(19) United States
(12) Patent Application Publication
(10) Pub. No.: US 2008/0267111 A1
(43) Pub. Date: Oct. 30, 2008

(54) Data Transmitting Method in Wireless Communication System

(75) Inventors: Hyoung-Soo Lim, Daejeon (KR); Dong-Seung Kwon, Daejeon (KR); Chung-Gu Kang, Seoul (KR); Hyun-Seok Ryu, Chungcheongbuk-do (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/094,549

(22) PCT Filed: Nov. 24, 2006
(86) PCT No.: PCT/KR2006/004967

§ 371 Date: May 21, 2008

(30) Foreign Application Priority Data
Nov. 24, 2005 (KR) 10-2005-01222802
Jun. 2, 2006 (KR) 10-2006-0049891

(51) Int. Cl. H04B 7/14

(52) U.S. Cl. 370/315

(57) ABSTRACT

In a method for transmitting data from a first node to a second node through first and second relay units in a wireless communication system: a) a first symbol is transmitted from the first node to the second node and the first relay unit during a first time slot section; b) the first symbol, which is received from the first node, is transmitted from the first relay unit to the second node during a second time slot section; c) a second symbol is transmitted from the first node to the second node and the second relay unit during the second time slot section; and d) the second symbol, which is received from the first node, is transmitted from the second relay unit to the second node during a third time slot section.

### TECHNICAL FIELD

The present invention relates to a data transmission method of a wireless communication system. More particularly, the present invention relates to a data transmission method for increasing performance of a bit error rate in a cooperative multi-input multi-output (MIMO) wireless communication system.

### BACKGROUND ART

A cooperative multi-input multi-output wireless communication system is also referred to as a collaborative or cooperative diversity system. It is difficult to realize multiple antennas with respect to sizes of terminals in a conventional MIMO system. Accordingly, in the cooperative MIMO wireless communication system, a virtual MIMO is realized by respective terminals sharing one antenna so as to solve the above difficulty. In addition, the cooperative MIMO wireless communication system obtains capacity/throughput that is higher than that of a conventional single input single output system and increases cell coverage, and therefore, it is regarded as a core technology of next generation mobile communication.

FIG. 1 and FIG. 2 show block diagrams representing data transmission in a conventional MIMO-based wireless communication system.

As shown in FIG. 1 and FIG. 2, the conventional MIMO-based wireless communication system includes a source station 10, a first relay station 20, a second relay station 30, and a destination station 40.

In a first time slot section (shown in FIG. 1), the source station 10 broadcasts a first symbol to the first relay station 20, the second relay station 30, and the destination station 40. In a second time slot section (shown in FIG. 2), the first and second relay stations 20 and 30 transmit the received first symbol to the destination station 40, and the source station 10 transmits a second symbol to the destination station 40. The conventional MIMO-based wireless communication system performs the first time slot section and the second time slot section so that the destination station 40 receives the second symbol of the source station 10 and the first symbol of the first and second relay stations 20 and 30. In this case, it is assumed that the first and second relay stations 20 and 30 may not receive symbol data while transmitting the symbol data.

The conventional MIMO system has a problem in that it is complicated to restore data received by the destination station.

In addition, a paper entitled “Cooperative Diversity in Wireless Networks: Efficient Protocols and Outage Behavior” in “IEEE Transaction on Information Theory, Vol.50 No. 12 pp.3062-3080” (December, 2004), disclosed the conventional cooperative diversity method. In this prior art, a relay station analyzes a signal received from a source station, compares the signal with a stored threshold, and performs stopover communication or serial communication, and a destination station determines whether the serial communication is successfully performed and transmits feedback information on the determined result so that the relay station re-transmits a previously received symbol.

In the above prior arts, there is a merit in that full diversity may be satisfied and serial communication may be efficiently provided in a limited number of stations. However, there is a problem in that bit error rate (BER) performance may be reduced when a plurality of stations are used or a deteriorated channel environment is provided.

The above information disclosed in this Background section is only for enhancement of understanding of the background of the invention and therefore it may contain information that does not form the prior art mat is already known in this country to a person of ordinary skill in the art.

### DISCLOSURE OF INVENTION

### Technical Problem

The present invention has been made in an effort to provide a data transmission method for improving bit error rate performance in a cooperative multi-input multi-output (MIMO)-based wireless communication system.

### Technical Solution

In an exemplary data transmission method for transmitting data from a first node to a second node through a first relay unit and a second relay unit in a wireless communication system according to an embodiment of the present invention: a) a first symbol is transmitted from the first node to the second node and the first relay unit during a first time slot section; b) the first symbol, which is received from the first node, is transmitted from the first relay unit to the second node during a second time slot section; c) a second symbol is transmitted from the first node to the second node and the second relay unit during the second time slot section; and d) the second symbol, which is received from the first node, is transmitted from the second relay unit to the second node during a third time slot section. After d), e) a third symbol is transmitted from the first node to the second node and the first relay unit during the third time slot section, and f) the third symbol, which is received from the first node, is transmitted from the first relay unit to the second node during a fourth time slot section.

In an exemplary data transmission method for transmitting data from a first node to a second node through a first relay unit and a second relay unit in a wireless communication system according to a second embodiment of the present invention: a) a first symbol is received from a first node by a second node during a first time slot section; b) during a second time slot section, a second symbol is received from the first node by the second node, and the first symbol (the first symbol of the first relay unit is received from the first node during the first time slot section) is received from the first relay unit by the second node; and c) during a third time slot section, a third symbol is received from the first node by the second node, and the second symbol (the second symbol of the second relay unit is received from the first node during the second time slot section) is received from the second relay unit by the second node.

Here, in b), b-1) the first symbol received during the first time slot section and the first and second symbols received during the second time slot section are used, the second symbol is detected, and the first symbol is restored, by the second node.

### Advantageous Effects

In the MIMO-based wireless communication system, there is a merit in that the BER performance may be improved while satisfying a full rate, since the destination station may calculate and detect a symbol when the plurality of stations are used or the deteriorated channel environment is provided.

In addition, without using multiple antennas, including two antennas, the plurality of symbols may be easily transmitted and detected by using one single antenna.

### BRIEF DESCRIPTION OF THE DRAWINGS

FIG. 1 and FIG. 2 show block diagrams representing data transmission in a conventional multi-input multi-output (MIMO)-based wireless communication system.

FIG. 3 to FIG. 6 show block diagrams representing data transmission in a wireless communication system according to an exemplary embodiment of the present invention.

FIG. 7 shows a data flowchart representing the data transmission method of the wireless communication system according to the exemplary embodiment of the present invention.

FIG. 8 shows a graph representing bit error rates (BER) and signal-to-noise ratios (SNR) according to the conventional data transmission method using cooperative MIMO transmission protocol and according to the data transmission of the exemplary embodiment of the present invention.

### BEST MODE FOR CARRYING OUT THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise”, and variations such as “comprises” or “comprising”, will be understood to imply the inclusion of stated elements but not the exclusion of any other elements.

A data transmission method of a wireless communication system according to an exemplary embodiment of the present invention will now be described.

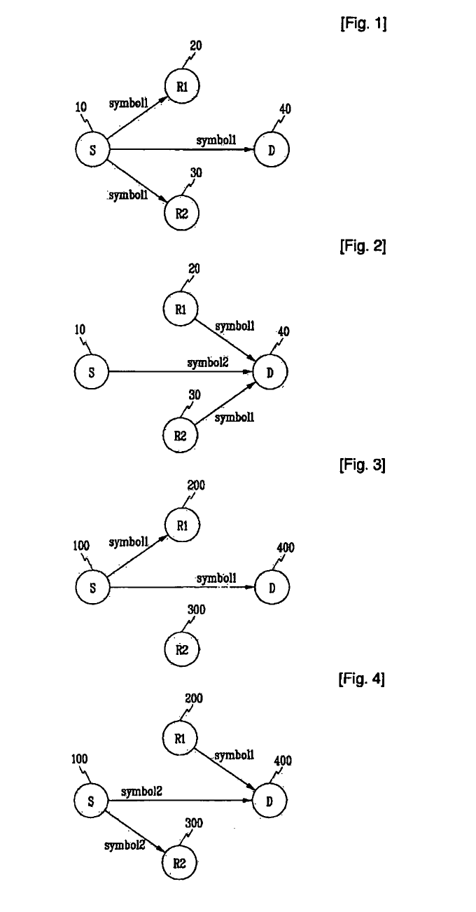

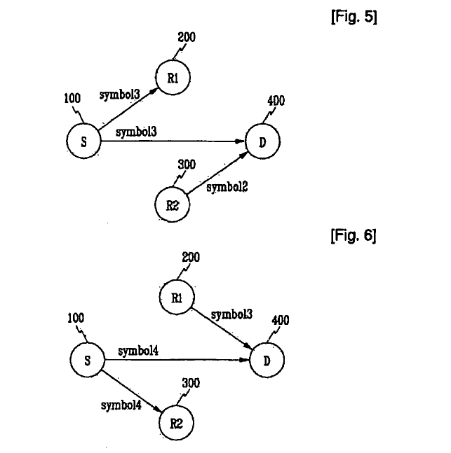

FIG. 3 to FIG. 6 show diagrams representing data transmission in the wireless communication system according to the exemplary embodiment of the present invention.

As shown in FIG. 3 to FIG. 6, the wireless communication system according to the exemplary embodiment of the present invention includes a source station, a relay station, and a destination station.

FIG. 3 to FIG. 6 respectively show symbol transmission during first to fourth time slot sections when the wireless communication system according to the exemplary embodiment of the present invention includes relay stations 200 and 300.

During the first time slot section, the source station 100 in the wireless communication system transmits a first symbol to a first relay station 200 and a destination station 400. In this case, in the source station 100, it is assumed that information on neighboring relay stations 200 and 300 is set or it is transmitted from a server before transmitting the first symbol.

During the second time slot section, the source station 100 transmits a second symbol to the second relay station 300 and the destination station 400, and simultaneously, the first relay station 200 transmits the first symbol stored during the first time slot section to the destination station 400.

In this case, the destination station 400 subtracts the first symbol, which is received from the source station during the first time slot section, from the delayed first symbol and the directly transmitted second symbol received from the source station 100 and the first relay station 200 during the second time slot section to calculate the second symbol.

In addition, the destination station 400 subtracts the calculated second symbol from the delayed first symbol and the directly transmitted second symbol received from the source station 100 and the first relay station 200 during the second time slot section to calculate the first symbol, and compares the calculated first symbol with the directly received first symbol during the first time slot section to generate the restored first symbol.

That is, the first symbol obtained by the subtraction is compared to the first symbol directly received during the first time slot selection, so that a first symbol restored by minimizing interference of noise and channel may be generated. Since the restored first symbol has a minimized BER, accuracy is highly increased.

During the third time slot section, the source station 100 transmits a third symbol to the first relay station 200 and the destination station 400, and simultaneously, the second relay station 300 transmits the second symbol, which is received and stored during the second time slot section, to the destination station 400.

In this case, the destination station 400 subtracts the second symbol calculated during the second time slot section from the directly received third symbol and the delayed second symbol received from the source station 100 and the second relay station 300 during the third time slot section to calculate the third symbol.

In addition, the destination station 400 subtracts the calculated third symbol from the directly received third symbol and the delayed second symbol received from the source station 100 and the second relay station 300 during the third time slot section to calculate the second symbol, and compares the calculated second symbol with the second symbol calculated during the second time slot section. That is, the second symbol calculated during the second time slot section is compared to the symbol 2 received during the third time slot section, so that the second symbol restored by minimizing the interference of noise and channel may be generated.

During the fourth time slot section, the source station 100 transmits a fourth symbol to the second relay station 300 and the destination station 400, and simultaneously, the first relay station 200 transmits the third symbol, which is received and stored during the third time slot section, to the destination station 400. In this case, the destination station 400 subtracts the third symbol calculated during the third time slot section from the fourth symbol and the third symbol received from the source station 100 and the second relay station 300 during the fourth time slot section to calculate the fourth symbol.

In addition, the destination station 400 subtracts the calculated fourth symbol from the direct fourth symbol and the delayed third symbol received from the source station 100 and the first relay station 200 during the fourth time slot section to calculate the symbol 3, compares the calculated third symbol with the third symbol calculated during the third time slot section, and generates the restored third symbol. That is, the third symbol obtained by the subtraction is compared with the third symbol calculated during the third time slot section, and the third symbol restored by minimizing the interference of noise and channel is generated.

In the wireless communication system based on a multi-input multi-output (MIMO) method, there is a merit in that the BER performance may be improved while satisfying a full rate, when the plurality of stations are used or a deteriorated channel environment is provided.

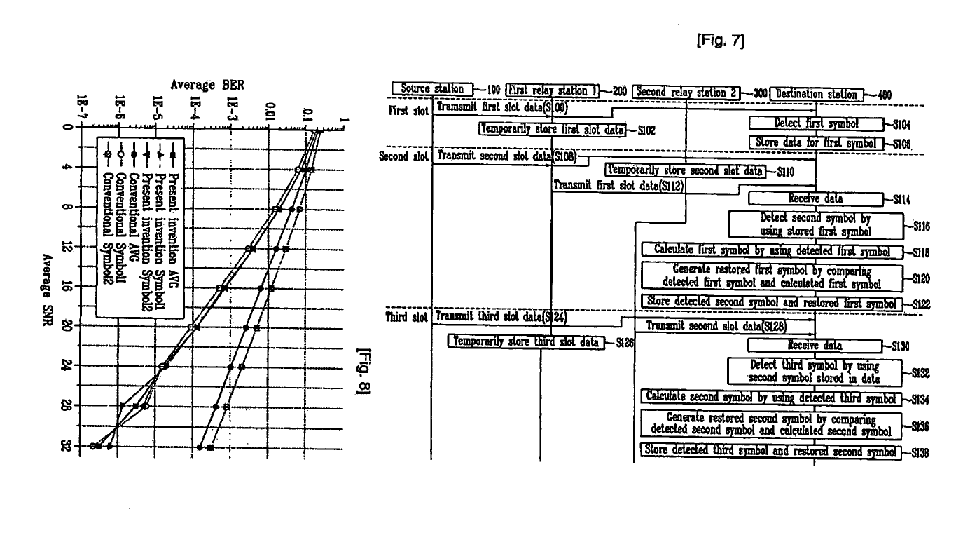

The MIMO-based wireless communication system will now be described with reference to FIG. 7.

FIG. 7 shows a diagram representing the data transmission method of the wireless communication system according to the exemplary embodiment of the present invention.

As shown in FIG. 7, the source station 100 of the wireless communication system according to the exemplary embodiment of the present invention transmits a plurality of data symbols directly to the destination station 400 or through the relay stations 200 and 300 according to the time slot sections.

The source station 100 transmits first slot data to the first relay station 200 and the destination station 400 during the first time slot section in step S100. In this case, the first slot data includes a first symbol to be transmitted by the source station 100.

Here, it is assumed that the source station 100 has previously set information about the neighboring relay stations 200 and 300 or has received the information from a server before transmitting the first slot data that are initial data.

The first relay station 200 receives the first slot data and temporarily stores them in step S102.

The destination station 400 receives the first slot data, detects the first symbol in step S104, and stores data for the first symbol in step S106.

The source station 100 transmits second slot data to the second relay station 300 and the destination station 400 during the second time slot section in step S108. In this case, the second slot data includes a second symbol.

The first relay station 200 transmits the first slot data received during the second time slot section to the destination station 400 in step S112.

The second relay station 300 receives the second slot data and temporarily stores them in step S110.

The destination station 400 receives the first slot data and the second slot data in step S114, subtracts the first symbol received during the first time slot section from the received data (first and second slot data), and detects the second symbol in step S116. In this case, the first slot data includes the delayed first symbol transmitted through the first relay station 200, and the second slot data includes the second symbol directly transmitted from the source station 100.

The destination station 400 subtracts the detected second symbol from the received data (the first and second slot data), and calculates the first symbol in step S118. In addition, the first symbol detected during the first time slot section and the first symbol calculated during the second time slot section are compared to generate a restored final data symbol1 in step S120. In this case, the restored symbol1 may be obtained by averaging each data bit included in the first symbol detected during the first time slot section and the first symbol calculated during the second time slot section, or it may be detected by using a soft-decision or a hard-decision method. In the exemplary embodiment of the present invention, the soft-decision method is used.

Subsequently, the destination station 400 stores the detected second symbol and the restored first symbol in step S122.

The source station 100 transmits the third slot data to the first relay station 200 and the destination station 400 during the third time slot section in step S124. In this case, the third slot data includes a third symbol.

The second relay station 300 transmits the second slot data received during the second time slot section, to the destination station 400 in step S128.

The first relay station 200 receives the third slot data and temporarily stores them in step S126.

The destination station 400 receives the second slot data and the third slot data in step S130, subtracts the second symbol detected during the second time slot section from the received data (the second and third slot data), and detects the third symbol in step S132. In this case, the second slot data includes the second symbol transmitted through the second relay station 300 and the third symbol directly transmitted from the source station 100.

The destination station 400 subtracts the detected third symbol from the received data (the second and third slot data), and calculates the second symbol in step S134. In addition, the calculated second symbol and the second symbol detected during the second time slot section are compared to generate the restored second symbol in step S136. In this case, the restored second symbol may be obtained by averaging each data bit included in the second symbol detected during the second time slot section and the second symbol calculated during the third time slot section, or it may be detected by using the soft-decision or hard-decision method. In the exemplary embodiment of the present invention, the soft-decision method is used.

Subsequently, the destination station 400 stores the restored second symbol and the detected third symbol in step S138.

In the MIMO-based wireless communication system according to the exemplary embodiment of the present invention, even when the number of relay stations is increased or the number of slot sections is increased, the destination station may easily detect a data symbol, which is transmitted from the source station, by repeatedly performing the above data transmission method.

In the MIMO-based wireless communication system, there is a merit in that the BER performance may be improved while satisfying a full rate, since the destination station may calculate and detect a symbol when the plurality of stations are used or the deteriorated channel environment is provided. In addition, without using multiple antennas including two antennas, the plurality of symbols may be easily transmitted and detected by using one single antenna.

FIG. 8 shows a graph representing bit error rates (BER) and signal-to-noise ratios (SNR) according to conventional data transmission using the cooperative MIMI transmission protocol, and according to data transmission of the exemplary embodiment of the present invention.

As shown in FIG. 8, the BER of the data transmission method transmitting the symbol1 and the symbol2 by using the MIMO-based wireless communication system according to the exemplary embodiment of the present invention is improved double that of the data transmission method transmitting the symbol1 and symboll2 by using the conventional protocol transmission method.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A data transmission method for transmitting data from a first node to a second node through a first relay unit and a second relay unit in a wireless communication system, the method comprising:
a) transmitting a first symbol from the first node to the second node and the first relay unit during a first time slot section;
b) transmitting the first symbol, which is received from the first node, from the first relay unit to the second node during a second time slot section;
c) transmitting a second symbol from the first node to the second node and the second relay unit during the second time slot section; and
d) transmitting the second symbol, which is received from the first node, from the second relay unit to the second node during a third time slot section.

2. The data transmission method of claim 1, wherein, after d):
e) transmitting a third symbol from the first node to the second node and the first relay unit during the third time slot section; and
f) transmitting the third symbol, which is received from the first node, from the first relay unit to the second node during a fourth time slot section.

3. The data transmission method of claim 1, wherein the first relay unit and the second relay unit stores the received symbols.

4. A data transmission method for transmitting data from a first node to a second node through a first relay unit and a second relay unit in a wireless communication system, the data transmission method comprising:
a) receiving a first symbol from a first node by a second node during a first time slot section;
b) during a second time slot section, receiving a second symbol from the first node by the second node, and receiving the first symbol (the first symbol of the first relay unit is received from the first node during the first time slot section) from the first relay unit by the second node; and
c) during a third time slot section, receiving a third symbol from the first node by the second node, and receiving the second symbol (the second symbol of the second relay unit is received from the first node during the second time slot section) from the second relay unit by the second node.

5. The data transmission method of claim 4, wherein b) comprises b-1) using the first symbol received during the first time slot section and the first and second symbols received during the second time slot section, detecting the second symbol, and restoring the first symbol, by the second node.

6. The data transmission method of claim 5, wherein b-1) comprises:
performing an operation of the first symbol received during the first time slot section and the first and second symbols received during the second time slot section, and detecting the second symbol, by the second node;
performing an operation of the detected second symbol and the first and second symbols received during the second time slot section, and detecting the first symbol, by the second node; and
comparing the detected first symbol and the first symbol received during the first time slot section, and restoring the first symbol, by the second node.

7. The data transmission method of claim 4, wherein c) comprises c-1) using the second symbol received during the second time slot section and the second and third symbols received during the third time slot section, detecting the third symbol, and restoring the second symbol.

8. The data transmission method of claim 7, wherein c-1) comprises:
performing an operation of the second symbol received during the second time slot section and the second and third symbols received during the third time slot section, and detecting the third symbol, by the second node;
performing an operation of the detected third symbol and the second and third symbols received during the third time slot section, and detecting the second symbol; and
comparing the detected second symbol and the second symbol received during the second time slot section, and restoring the second symbol, by the second node.
